(19) United States
(12) Patent Application Publication
(10) Pub. No.: US 2025/0206362 A1
(43) Pub. Date: Jun. 26, 2025

(54) A HAND TROLLEY FOR RECEIVING AND TRANSPORTING A LEGGED FRACTIONAL DISPLAY PLATFORM

(71) Applicant: CHEP Technology Pty Limited, Sydney (AU)

(72) Inventors: Daniel LOPEZ URAN, Weybridge Surrey (GB); Nicolas CAPPUYNS, Weybridge Surrey (GB)

(21) Appl. No.: 18/851,892

(22) PCT Filed: Mar. 27, 2023
(86) PCT No.: PCT/GB2023/050792

§ 371 Date: Sep. 27, 2024

(30) Foreign Application Priority Data
Mar. 31, 2022 (GB) 2204641.1

(51) Int. Cl. B62B 1/14; B62B 1/26; B65D 19/00

(52) U.S. Cl. CPC B62B 1/14; B62B 1/268; B65D 19/0018; B62B 2203/22

(57) ABSTRACT

A fractional display platform hand trolley 7 for receiving and transporting a legged fractional display platform 1, the fractional display platform 1 having a loading surface 2 for carrying items on the fractional display platform 1 and at least one leg 4 for supporting the loading surface 2. The hand trolley 7 comprises a first display-platform-leg lateral support structure 20 for providing lateral support to the display platform 1; and a second display-platform-leg lateral support structure 21 for providing lateral support to the display platform 1. The first display-platform-leg lateral support structure 20 is configured to engage with a leg 4 of the display platform 1 when the display platform 1 is received by the hand trolley 7 such that lateral support of display platform 1 on the trolley 7 is provided in a first lateral direction by the first display-platform-leg lateral support structure 20. The second display-platform-leg lateral support structure 21 is configured to engage with a leg 4 of the display platform 1 when the display platform 1 is received by the hand trolley 7 such that lateral support of display platform 1 on the trolley 7 is provided in a second lateral direction, opposite to the first lateral direction, by the second display-platform-leg lateral support structure 21.

The present invention relates to a hand trolley for receiving and transporting a legged display platform. In particular, but not exclusively, the present invention may be embodied as a legged fractional display platform (such as a European quarter pallet, a North American half display platform or an Australian sixth pallet) hand trolley for receiving and transporting a legged fractional display platform.

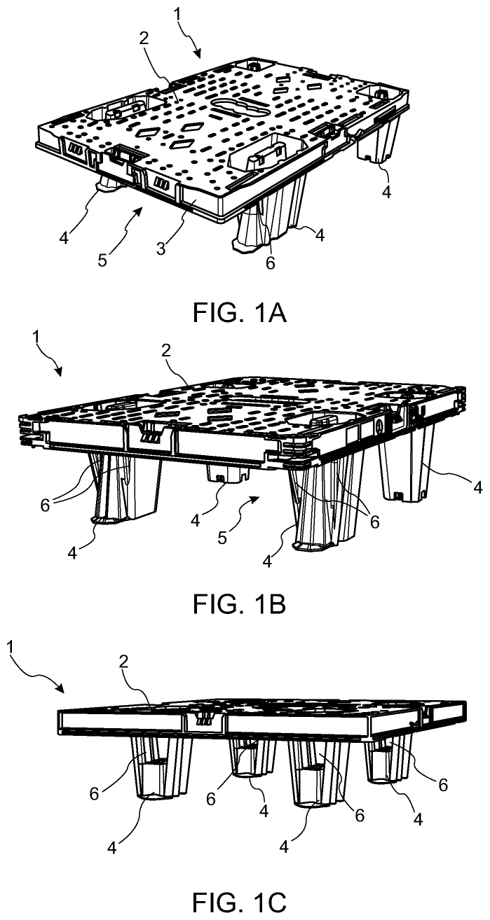

A fractional display platform, which are also referred to as a fractional display unit in the art, are used to transport goods, particularly to and from and around retail floorspace. Fractional display platforms are referred to as “fractional” because they are smaller than a typical, full-size pallet and standard sizes are about a half, a quarter, a sixth (and so on) the size of a typical, full-size pallet. Examples of fractional display platforms include the European quarter pallet (being 600×400 mm in size), the North American half display platform and quarter display platform (e.g. 40×24″ and 20×48″ in size), and Australian sixth pallet (582×387 mm in size). Legged fractional display platforms comprise a loading surface, or deck, for receiving items to be transported thereupon by the display platform, the loading surface being supported above the ground (when the fractional display platform is placed upon the ground), by legs, usually four legs with one leg provided generally at each corner of the fractional display platform, fractional display platforms typically being rectangular in shape. Fractional display platforms may be used in various ways but commonly they are used within retail shops such as supermarkets, commonly to transport goods for sale to and from and around the shop floor. Fractional display platforms are particularly used as point-of-sale displays or to transport them thereupon. Examples of fractional display platforms of the prior art suitable for use with the present invention are show in FIGS. 1A to 1C.

Currently, the standard method for transporting fractional display platforms is to use pallet jacks. Of course pallet jacks are designed for use with full size pallets and are not intended or designed to transport fractional display platforms and, in being so designed, have two very large and spaced apart tines upon which a full size pallet can be supported. As a result, transporting fractional display platforms on a pallet jack is a precarious task because the fractional display platforms are, as a matter of standard practice, loaded onto the pallet jack by balancing one fractional display platform on each of the jack's tines. The tines of the jack are specifically sized and spaced-apart from each other for engaging with the blocks of a full size pallet and so it is not possible to position the fractional display platform such that it is suitably supported by both tines. This means that that the fractional display platforms, or stack of fractional display platforms (as often empty fractional display platforms are transported by being stacked on top of each other), or point-of-sale display carried thereupon, is liable to topple or slide and fall off of the pallet jack. This coupled with a pallet jack's poor manoeuvrability, heavy weight and large size increases the risk of an accident. Furthermore, pallet jacks, partly due to the reasons listed above, are very time inefficient and time efficiency and speed of deployment (e.g. of point of sale displays) is often a crucial factor in logistics and in the retail industry.

In contrast, hand trolleys are also known. These are traditional L-shaped user-operated devices, often constructed from a tubular frame, with handles at one end, two coaxial locomotive wheels at the base, and a small flat and often rectangular platform or ledge to carry items on top of when the hand trolley is tilted backwards. Hand trolleys are traditionally (and still to this day) used for carrying items such as boxes and sacks. Hand trolleys, while solving some problems of a pallet jack, suffer from some of the same problems as pallet jacks—for example a point of sale display loaded upon a traditional hand trolley is unstable and also prone to accidents as the traditional style of hand trolley is not intended or designed to be used for carrying legged fractional display platforms. It is therefore not standard practice to use a hand trolley for carrying fractional display platforms and, despite the problems with pallet jacks, pallet jacks remain the preferred device for transporting fractional pallets, such is the severity of the problems associated with hand trolleys for transporting fractional display platforms.

There therefore exists a need for an improved device for transporting fractional display platforms which is faster, cheaper, more manoeuvrable, more time and space efficient and which is able to transport a fractional display platform (or stack thereof) thereupon in a safer, stable and more convenient way.

The present invention aims to alleviate, at least to a certain extent, the problem and/or address at least to a certain extent the difficulties associated with the prior art

According to a first aspect of the present invention, there is provided a fractional display platform hand trolley for receiving and transporting (and optionally for also lifting) a legged fractional display platform, the fractional display platform having a loading surface for carrying items on the fractional display platform and at least one leg for supporting the loading surface, the hand trolley comprising:
a first display-platform-leg lateral support structure for providing lateral support to the display platform;
a second display-platform-leg lateral support structure for providing lateral support to the display platform; and
wherein the first display-platform-leg lateral support structure is configured to engage with a leg of the display platform when the display platform is received by the hand trolley such that lateral support of pallet on the hand trolley is provided in a first lateral direction by the first display-platform-leg lateral support structure; and
wherein the second display-platform-leg lateral support structure is configured to engage with a leg of the display platform when the display platform is received by the hand trolley such that lateral support of display platform on the hand trolley is provided in a second lateral direction, opposite to the first lateral direction, by the second display-platform-leg lateral support structure.

The present invention therefore solves the problem of how to transport fractional display platforms quickly, safely and in a space-efficient manner by providing a hand trolley (e.g. a manually-operated hand trolley) for receiving and transporting fractional display platforms. The present invention is therefore particularly advantageous for moving stock and point of sale display units between the storage area of a shop, for example, and the shop-floor and for repositioning stock and display units around the shop-floor without requiring cumbersome and potentially dangerous heavy-machinery such as a fork-lift or a pallet-truck with poor manoeuvrability, greatly increasing the time and space efficiency associated with moving fractional display platforms around a shop, thereby greatly increasing the ability of a retail shop to adjust to changing demand and footfall patterns. The first and second display-platform-leg lateral support structures laterally support the display platform when it is received by the trolley and during transportation of the display platform on the trolley so that the display-platform-leg lateral support structures prevent or at least resist lateral movement (that is side-to-side movement, the lateral direction being perpendicular to the normal direction of travel of the hand trolley, i.e. parallel to the axle of a locomotive wheel of the trolley, e.g. a rear wheel) which could otherwise cause the display platform, or stack of display platforms when one or more other display platforms are stacked and received by the trolley, to rock, tip or slide or otherwise fall off the trolley or for the stack to collapse. The term “hand trolley” (or sometimes “hand truck”) is a term of the art and describes a category of trolley quite distinct from pallet jacks (or sometimes referred to as “pallet trucks”), such as manual pallet jacks (or manual pallet trucks) or forklift trucks. The legged fractional display platform of any or all aspects of the present invention may form part of a point-of-sale display or a display unit (for example the fractional display platform may be integrally formed with a point-of-sale display or a display unit), or a point-of sale display or display unit may be carried by, or loaded onto, or supported by, or attached to, or otherwise associated with the legged fractional display platform. The legged fractional display platform of any or all aspects of the present invention may be a European quarter pallet, an Australian sixth pallet, a North American half display platform, or a North American quarter display platform, or any other such suitable legged fractional display platform or fractional pallet.

Optionally, the first display-platform-leg lateral support structure and second display-platform-leg lateral support structure are both configured to engage with a first leg of the display platform when the display platform is received by the hand trolley so as to provide lateral support to the first leg in both the first and second lateral directions. Thus, the first and second display-platform-leg lateral support structures are configured to engage with the same leg of the display platform so as to provide lateral support to the trolley by laterally supporting a leg of the display platform and may be configured to interlockingly or matingly engage with the leg.

Optionally, the first display-platform-leg lateral support structure is configured to engage with a first leg of the display platform when the display platform is received by the hand trolley so as to laterally support the first leg of the display platform in the first lateral direction, and
wherein the second display-platform-leg lateral support structure is configured to engage with the second leg of the display platform when the display platform is received by the hand trolley so as to laterally support the second leg of the display platform in the second lateral direction.

Thus, the first and second display-platform-leg lateral support structures are configured to engage with respective, i.e. different, legs of the display platform so as to provide lateral support to the trolley by laterally supporting different legs of the display platform. Optionally, the first lateral support and second lateral support are configured to be slidingly received by respective apertures, or guides, provided in the first leg and second leg respectively such that moving the trolley towards the display platform causes the first and second supports to be received by their respective aperture, or guide, of their respective display platform leg.

Optionally, the first display-platform-leg lateral support structure comprises a support member configured to engage (e.g. slidingly engage) with a side of the first leg of the display platform when the display platform is received by the hand trolley so as to provide lateral support to the display platform on the trolley in the first direction, optionally wherein the first display-platform-leg lateral support structure comprises a further support member configured to engage (e.g. slidingly engage) with an opposite side of the first leg of the display platform when the display platform is received (e.g. slidingly received) by the hand trolley so as to provide lateral support to the display platform on the trolley in the second direction. The support member may optionally comprise a projection or a finger.

Optionally, the first display-platform-leg lateral support structure comprises at least one finger configured to be slidingly received by a corresponding aperture provided in the first leg of the display platform when the display platform is received by the trolley, optionally so as to provide lateral support to the display platform on the trolley.

Optionally, the first display-platform-leg lateral support structure comprises two, optionally laterally spaced-apart, fingers configured to be slidingly received by corresponding apertures provided in the first leg of the display platform when the display platform is received by the trolley so as to provide lateral support to the display platform on the trolley. Optionally, the fingers may be provided on respective sides of a centreline of the first leg of the display platform.

Optionally, the two fingers define a finger void space therebetween, the finger void space being configured to receive (e.g. slidingly receive) a first leg of the display platform. Thus the two fingers may define a boundary or extent of the finger void space. Optionally, the finger void space may extend directly between the two fingers.

Optionally, the second display-platform-leg lateral support structure comprises a support member configured to engage (e.g. slidingly engage) with a side of the second leg of the display platform when the display platform is received (e.g. slidingly received) by the hand trolley so as to provide lateral support to the display platform on the trolley in the second direction, optionally wherein the second display-platform-leg lateral support structure comprises a further support member configured to engage (e.g. slidingly engage) with an opposite side of the second leg of the display platform when the display platform is received (e.g. slidingly received) by the hand trolley so as to provide lateral support to the display platform on the trolley in the first direction. The support member may optionally comprise a projection or a finger.

Optionally, the second display-platform-leg lateral support structure comprises at least one finger configured to be slidingly received by a corresponding aperture provided in the second leg of the display platform when the display platform is received by the trolley, optionally so as to provide lateral support to the pallet on the trolley.

Optionally, the second display-platform-leg lateral support structure comprises two, optionally laterally spaced-apart, fingers configured to be slidingly received by corresponding apertures provided in the second leg of the display platform when the display platform is received by the trolley so as to provide lateral support to the display platform on the trolley. Optionally, the fingers may be provided on respective sides of a centreline of the first leg of the display platform.

Optionally, the two fingers define a finger void space therebetween, the finger void space being configured to receive a first leg of the display platform. Thus the two fingers may define a boundary or extent of the finger void space. Optionally, the finger void space may extend directly between the two fingers.

Optionally, the hand trolley further comprises a display platform deck for receiving thereupon and thereafter transporting thereupon a legged fractional display platform when the legged fractional display platform is received by the trolley. Optionally, the hand trolley further comprises a display platform deck for receiving thereupon a fractional display platform when the fractional display platform is received by the trolley.

Optionally, the display platform deck comprises a ledge arranged between the first and second display platform-leg lateral support structures, the ledge being configured to extend underneath (e.g. to be slid underneath) the display platform and between the first and second legs of the display platform when the display platform is received by the trolley so as to support the display platform thereupon, optionally wherein the ledge is substantially planar. Thus the ledge may be slid underneath a raised base (raised with respect to the ground) of the display platform, the base being supported by one or more display platform legs, so as to pick up or lift the display platform thereupon.

Optionally, the ledge comprises a guide portion of reduced width, for example the guide portion comprising a first and a second angled or rounded guide edge on respective opposed lateral sides of the ledge so as to facilitate the engagement of the ledge between the first and second legs of the display platform. Thus the ledge may optionally comprise a rounded or chamfered end, optionally the rounded or chamber end is provided at or towards a front end of the display platform deck.

Optionally, the display platform deck is substantially planar. Optionally the display platform deck may be formed of a sheet of material, for example sheet metal.

Optionally, the first and/or second display-platform-leg lateral support structures are integrally formed with the display platform deck. Thus, the display platform deck and the first and/or second display-platform-leg lateral support structures (which may optionally include the support members or fingers) may be formed from the same sheet of material.

Optionally, the first and/or second display-platform-leg lateral support structures (which may optionally include the support members or fingers) are substantially co-planar with the display platform deck or ledge.

Optionally, the display platform deck comprises:
a first display-platform-leg lateral support surface, or edge, configured to engage with the first leg of the display platform when the display platform is received by the hand trolley so as to provide lateral support the first leg of the display platform in the second lateral direction; and
a second display-platform-leg lateral support surface, or edge, configured to engage with the second leg of the display platform when the display platform is received by the hand trolley so as to provide lateral support to the second leg of the display platform in the first lateral direction.

Optionally, the support member of the first and/or second display-platform-leg lateral support structures, the fingers of the first and/or second display-platform-leg lateral support structures, and/or the display platform deck (or ledge thereof) are arranged within a common plane.

Optionally, the first and second display-platform-leg lateral support structures are configured to provide interlocking engagement with the first and second legs of the display platform respectively.

Optionally, the finger void spaces, are provided as slots within the display platform deck.

Optionally, the display platform deck is substantially planar and wherein the first and second display-platform-leg lateral support structures are defined by a profiled edge, e.g. a cutout, of the display platform deck,
e.g. wherein the support members are defined by a profiled edge, e.g. a cutout, of the display platform deck, and/or,
wherein the fingers are defined by a profiled edge, e.g. a cutout, of the display platform deck. Thus the support members, ledge and fingers may all be defined by a common, or continuous, profiled edge

Optionally, the profiled edge is provided on a front edge of the display platform deck. The front edge is the forwardmost edge in the normal direction of travel of the trolley, spaced furthest away from the handles or locomotive wheel (or rear wheel).

Optionally, the trolley comprises at least one locomotive wheel comprising a wheel rotation axis, and wherein the trolley is user-tiltable about a tilt-axis for lifting the display platform onto the trolley, preferably wherein the tilt-axis is coaxial with the locomotive wheel rotation axis, into a wheeled transportation mode for transporting the display platform on the trolley. Thus the hand trolley may be tilted backwards, as is usual for hand trolleys, while transporting the fractional display platform thereupon. Optionally the locomotive wheel is rear wheel of the trolley.

Optionally, the fingers have a longitudinal axis which extends in a direction generally or substantially perpendicular to wheel rotation axis, optionally in a forward direction of the hand trolley. Optionally, the fingers have a longitudinal axis which extends in a direction generally or substantially perpendicular to the lateral axis.

Optionally, the hand trolley comprises at least one handle, preferably two handles, for manoeuvring the trolley, wherein the at least one handle is provided on one side of the tilt-axis and wherein the display platform deck is provided on the other side of the tilt-axis such that pushing the handle in one direction (e.g. downwards) on one side of the tilt-axis causes the display platform deck to move in the opposite direction (e.g. upwards) such that the trolley tilts about the tilt axis so as to lift a display platform received by the trolley.

Optionally, the trolley comprises a substantially or generally upright support or frame to which the locomotive wheel, the display platform deck and at least one handle are attached Optionally wherein the hand trolley is substantially L shaped, optionally the display platform deck defines one branch of the L-shape and the upright support or frame defines the other branch. Optionally the frame may comprise two upright members and a plurality of structural members or rungs extending therebetween.

Optionally, the hand trolley comprises a substantially planar display platform deck for receiving thereupon and (thereafter) transporting thereupon a quarter-display platform and wherein the frame extends generally upwardly so as to define an obtuse angle with the planar loading surface. Thus, when not in tilted backwards in the transportation mode and when resting on the ground, the generally upright support is inclined backwards or rearwardly, with its top being further spaced from the display platform deck than its bottom.

Optionally, the locomotive wheel is a rear wheel of the hand trolley, the rear wheel comprising a rear wheel rotation axis;
the hand trolley further comprising:
an extendable front support spaced ahead of the rear wheel rotation axis;
the extendable front support being reconfigurable between an extended configuration and a retracted configuration, wherein the height of the front support in the extended configuration is greater than in the retracted configuration, such that, when the trolley is supported on the ground by both the at least one rear wheel and the extendable front support and when the extendable front support is in the retracted configuration, the display platform (e.g. a front portion of the display platform deck) is lowered (e.g. tilted, e.g. a front portion thereof is tilted) more towards the ground than when the trolley is supported on the ground by both the at least one rear wheel and the extendable front support and when the extendable front support is in the extended configuration.

Optionally, the extendable front support comprises a front support member and a bracket for mounting the front support member to the hand trolley.

Optionally, the front support member comprises a front wheel comprising a front wheel axle, the extendable front support being reconfigurable between a front wheel extended configuration and a front wheel retracted configuration in which the distance between the front wheel axle and the display platform deck is less in the front wheel retracted configuration than in the front wheel extended configuration such that, when the trolley is supported on the ground by both the at least one rear wheel and the front wheel and when the extendable front support is in the front wheel retracted configuration, the display platform deck (e.g. a front portion of the display platform deck) is lowered (e.g. tilted) more towards the ground than when the trolley is supported on the ground by both the at least one rear wheel and the front wheel and when the extendable front support is in the front wheel extended configuration.

Optionally, the bracket comprises a first stop and a second stop, wherein both the first stop and second stop are configured to receive the front support member;
and wherein the first stop is arranged closer to the display platform deck than the second stop is such that the first stop defines the front wheel retracted position and the second stop defines the front wheel extended position;
a guide configured to slidably guide the front wheel axle to and from the first stop and second stop. Optionally, wherein both the first stop and second stop are configured to receive the front wheel axle.

Optionally, the first stop is spaced further from the rear wheel rotation axis than the second stop is. For example, wherein the first stop is arranged further towards the front of the hand trolley than the second stop.

Optionally, the guide is provided as a slot within the bracket, optionally wherein the first and second stops are provided at opposed ends of the slot.

Optionally, the first and second stops are provided as first and second notches respectively within the slot, optionally wherein the notches extend from the slot towards the display platform deck.

Optionally, the slot defines a track for guiding the front support member therealong. Optionally, wherein the track comprises a generally or substantially linear section, optionally wherein the display platform deck is generally or substantially planar and wherein the linear section is inclined with respect to the planar plane of the display platform deck. Optionally, wherein the slot defines a track for guiding the front wheel axle therealong.

Optionally, the extendable front support is arranged towards a front portion of the display platform deck, e.g. attached to a front portion of the display platform deck.

Optionally, the extendable front support is configured such that tilting the hand trolley (e.g. rearwardly) about the rear wheel rotation axis causes the extendable front support to reconfigure to and from the extended configuration (e.g. the front wheel extended configuration) and the retracted configuration (e.g. the front wheel retracted configuration).

Optionally, the extendable front support is provided on an underside of the display platform deck.

Optionally, the hand trolley is manually-propelled. Thus the trolley may have no other means of propulsion other than being propelled, e.g. pushed or pulled, by a user.

According to a second aspect of the present invention, there is provided a legged fractional display platform and a hand trolley according to the first aspect, e.g. as a kit of parts. Optionally, the display platform comprises at least two legs each comprising one or more, preferably two, apertures configured to receive the fingers of the first and second display-platform-leg support structures respectively.

According to a third aspect of the present invention, there is provided a method of receiving and transporting a legged fractional display platform on a fractional display platform hand trolley according to any preceding claim, the hand trolley comprising a display platform deck for receiving thereupon and thereafter transporting thereupon a legged fractional display platform when the legged fractional display platform is received by the trolley, the method comprising the step of:
receiving a legged fractional display platform on the hand trolley by positioning the display platform deck under the loading surface when the display platform is positioned on the ground such that the first display-platform-leg lateral support structure slidingly engages with a first leg of the display platform so as to provide lateral stability to the first leg and such that the second display-platform-leg lateral support structure slidingly engages with a second leg of the display platform so as to provide lateral stability to the second leg such that the display platform is laterally supported with respect to the hand trolley by the first and second display-platform-leg lateral supports.

Optionally, the hand trolley comprises at least one locomotive wheel comprising a wheel rotation axis, and wherein the trolley is user-tiltable about the locomotive wheel rotation axis into a wheeled transportation mode for transporting the display platform on the trolley, the method comprising the steps of, after the step of receiving the display platform on the hand trolley:
tilting the hand trolley about the locomotive wheel rotation axis into a wheeled transportation mode of the hand trolley such that the display platform deck lifts the trolley off the ground; and
transporting the display platform upon the hand trolley while the hand trolley is tilted into the wheeled transportation mode.

According to a fourth aspect of the present invention, there is provided a hand trolley for lifting and transporting a fractional display platform thereupon, the hand trolley comprising: at least one rear wheel comprising a rear wheel rotation axis about which the rear wheel is configured to rotate;
a display platform deck for receiving a fractional display platform thereupon;
an extendable front support spaced ahead of the rear wheel rotation axis;
the extendable front support being reconfigurable between an extended configuration and a retracted configuration, wherein the height of the front support in the extended configuration is greater than in the retracted configuration, such that, when the trolley is supported on the ground by both the at least one rear wheel and the extendable front support and when the extendable front support is in the retracted configuration, the display platform deck (e.g. a front portion of the display platform deck) is tilted more towards the ground than when the trolley is supported on the ground by both the at least one rear wheel and the extendable front support and when the extendable front support is in the extended configuration.

Optionally, the extendable front support comprises a front support member and a bracket for mounting the front support member to the hand trolley.

Optionally, the front support member comprises a front wheel comprising a front wheel axle, the extendable front support being reconfigurable between a front wheel extended configuration and a front wheel retracted configuration in which the distance between the front wheel axle and the display platform deck is less in the front wheel retracted configuration than in the front wheel extended configuration such that, when the trolley is supported on the ground by both the at least one rear wheel and the front wheel and when the extendable front support is in the front wheel retracted configuration, the display platform deck (e.g. a front portion of the display platform deck) is tilted more towards the ground than when the trolley is supported on the ground by both the at least one rear wheel and the front wheel and when the extendable front support is in the front wheel extended configuration

Optionally, the bracket comprises a first stop and a second stop, wherein both the first stop and second stop are configured to receive the front support member;
and wherein the first stop is arranged closer to the display platform deck than the second stop is such that the first stop defines the front wheel retracted position and the second stop defines the front wheel extended position;
a guide configured to slidably guide the front wheel axle to and from the first stop and second stop. Optionally, wherein both the first stop and second stop are configured to receive the front wheel axle;

Optionally, the first stop is spaced further from the rear wheel rotation axis than the second stop is. Optionally, wherein the first stop is arranged further towards the front of the hand trolley than the second stop.

Optionally, the guide is provided as a slot within the bracket, optionally wherein the first and second stops are provided at opposed ends of the slot.

Optionally, the first and second stops are provided as first and second notches respectively within the slot, optionally wherein the notches extend from the slot towards the display platform deck.

Optionally, the slot defines a track for guiding the front support member therealong. Optionally, wherein the track comprises a generally or substantially linear section, optionally wherein the display platform deck is generally or substantially planar and wherein the linear section is inclined with respect to the planar plane of the display platform deck. Optionally, wherein the slot defines a track for guiding the front wheel axle therealong.

Optionally, the extendable front support is arranged towards a front portion of the display platform deck, e.g. attached to a front portion of the display platform deck.

Optionally, the extendable front support is configured such that tilting the hand trolley (e.g. rearwardly) about the rear wheel rotation axis causes the extendable front support to reconfigure to and from the extended configuration (e.g. the front wheel extended configuration) and the retracted configuration (e.g. the front wheel retracted configuration).

Optionally, the extendable front support is provided on an underside of the display platform deck.

The present invention may be carried out in various ways and a preferred embodiment of a fractional display platform hand trolley for receiving and transporting a fractional display platform in accordance with the invention will now be described by way of example with reference to the accompanying drawings, in which:

FIGS. 1A to 1C are a perspective views of a fractional display platform according to the prior art, suitable for use with the present invention. FIG. 1A shows a European quarter pallet, FIG. 1B shows an Australian sixth pallet and FIG. 1C shows a North American quarter display platform.

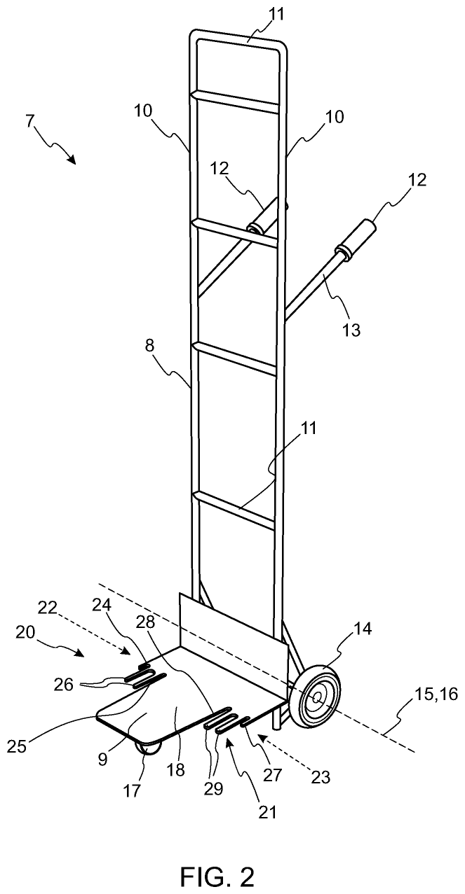

FIG. 2 is a perspective view of a fractional pallet hand trolley according to a preferred first embodiment of the present invention.

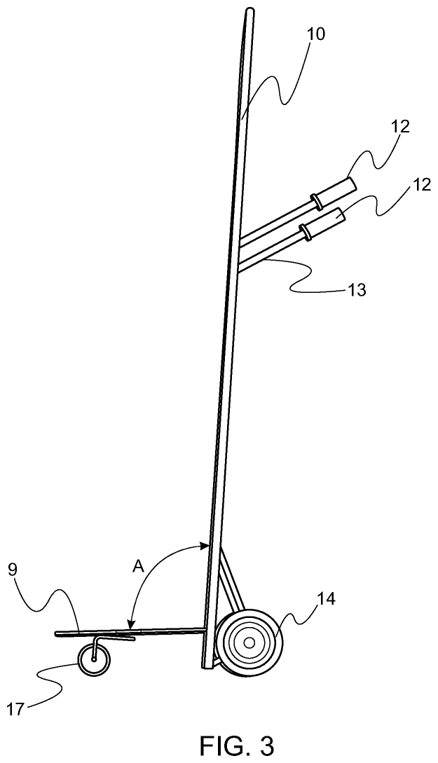

FIG. 3 is a side view of the hand trolley of FIG. 2 showing a set of handles at the rear of the hand trolley and a display platform deck at the front of the hand trolley for receiving a display platform and transporting the display platform thereupon.

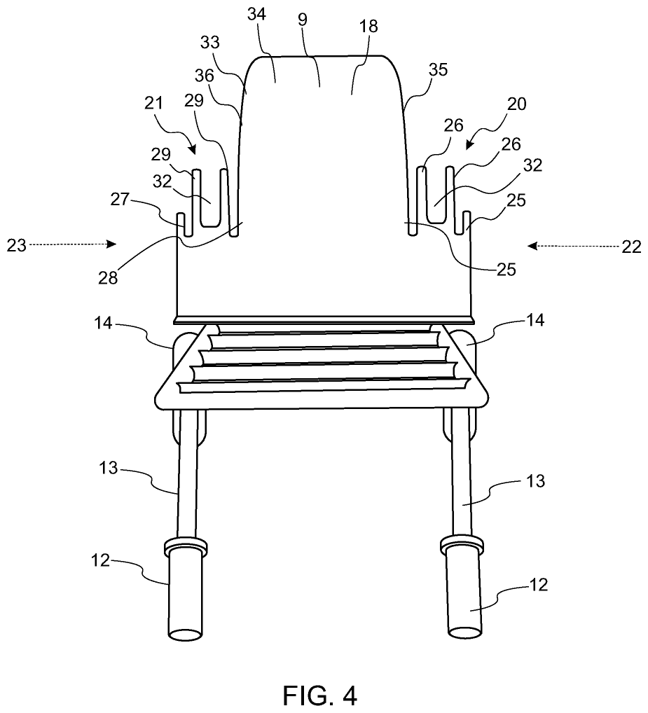

FIG. 4 is a plan view of the hand trolley of FIG. 2 showing a set of handles at the rear of the hand trolley, the rear portion, or frame, of the hand trolley and the display platform deck at the front of the hand trolley for receiving and transporting a display platform.

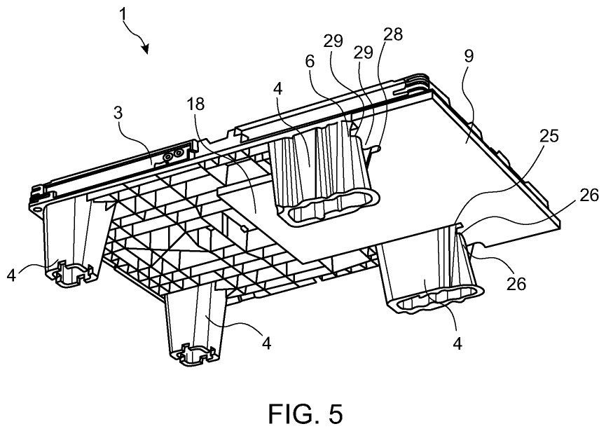

FIG. 5 is a perspective view of a fractional display platform being received on an alternative display platform deck of the hand trolley of FIG. 2, also forming part of the present invention, showing the first and second display-platform-leg lateral support structures in sliding mating engagement with respective legs of the display platform so as to provide lateral stability to the display platform on the trolley. This alternative display platform deck differs from the display platform deck on FIG. 2 only in the omission of the guide edge, first and second angled edges and in that the first and second display-platform-leg lateral support structures each comprise two fingers but do not comprise one of the support members configured to engage with a side of the first leg of the display platform when the display platform is received by the hand trolley. The engagement of fingers of the display platform deck are shown, the fingers being slidingly received by corresponding apertures or slots provided in two of the legs of the display platform, two fingers being received within two corresponding apertures per leg.

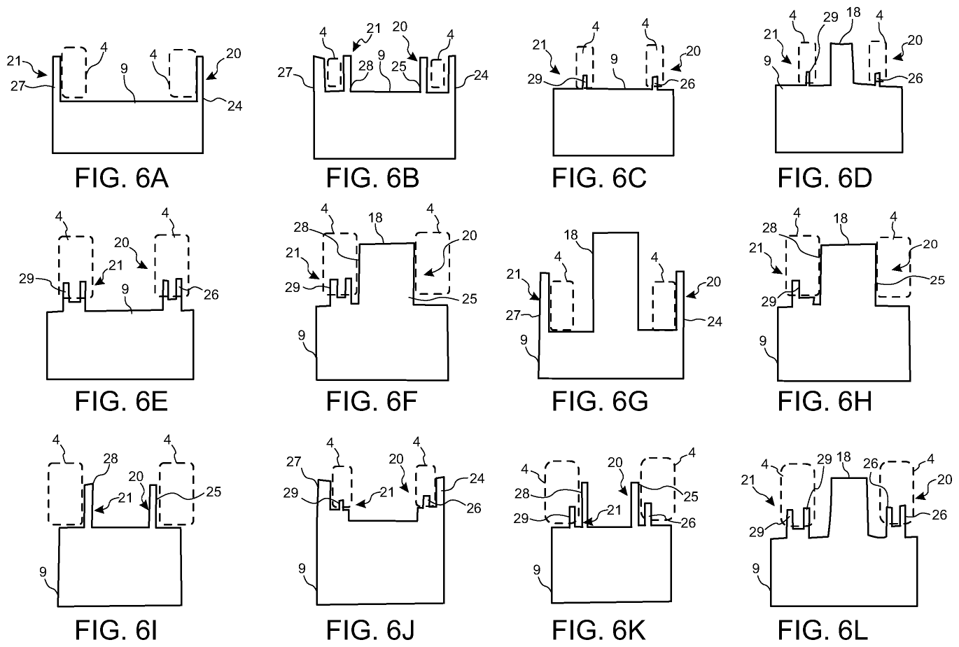

FIGS. 6A to 6L show various ways in which the first and second display-platform-leg support structures of the present invention may be embodied. Thus, FIGS. 6A to 6L show alternative configurations of the first and second display-platform-leg support structures falling within the scope of the present invention.

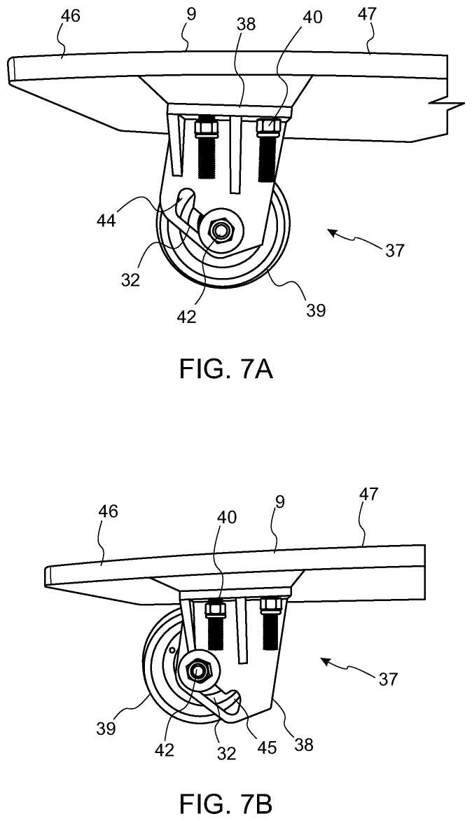

FIGS. 7A and 7B show the embodiment of FIG. 2 but, instead of the fixed wheel shown in FIG. 2, an extendable front support for supporting the front of the hand trolley on the ground is provided, here the extendable front support is in the form of a wheel and a bracket. All other aspects of the embodiment of FIG. 2 are identical.

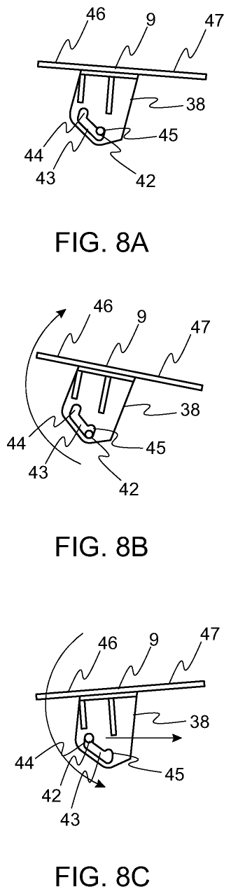

FIGS. 8A, 8B and 8C show the arrangement of the bracket and the progression from FIGS. 8A to 8C show the way in which the front wheel axle moves from an extended configuration of the extendable front support to a retracted configuration by tilting the hand trolley rearwardly.

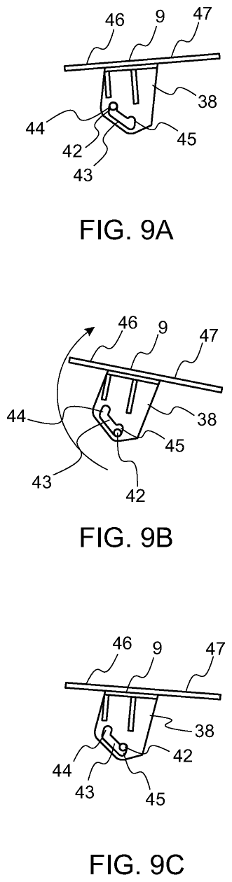

FIGS. 9A, 9B and 9C show the arrangement of the bracket and the progression from FIGS. 9A to 9C show the way in which the front wheel axle moves from an extended configuration of the extendable front support to a retracted configuration by tilting the hand trolley rearwardly.

A legged fractional display platform 1 according to the prior art is shown in FIG. 1A. This legged fractional display platform 1 is suitable for use with the present invention and happens to be a European quarter pallet, although the present invention is suitable for use with other legged fractional display platforms of other standard sizes and types, for example the factional display platforms and pallets shown in FIGS. 1B and 1C. The legged fractional display platform 1 comprises a loading surface 2 for carrying items, such as a point-of-sale display, thereupon. Being a quarter-pallet in this particular example, the loading surface 2 is approximately a quarter of the size of that of a standard full size pallet (i.e. the area of the loading surface is about a quarter of the surface area of the loading surface of a standard full size pallet) and is generally rectangular in shape, although other shapes could also be used as part of this invention and may be selected to correspond with the shape or packing arrangement of the item(s) to be placed thereupon (and in some embodiments, therein, because the display platform may comprise features, for example upstanding walls, which define a perimeter or boundary for receiving items therein). The loading surface 2 is part of a display platform base 3 which is supported or raised above the ground (when the display platform 1 is placed upon the ground) by at least one display platform leg 4 to provide a gap 5 between the ground and the display platform base 3. The gap 5 is sized so as to receive therein a display platform deck 9 (FIG. 2) of the hand trolley 7. In this example, four display platform legs 4 are provided, each generally arranged at respective corners of the display platform 1, although examples with one, two, three or more legs are also envisaged as part of the present invention. The display platform legs 4 may also be referred to as display platform blocks, this being a term of the art.

In the example display platform 1 of FIG. 1A, two of the display platform's four legs 4 comprise apertures 6 or slots 6 extending therein. These two legs 4 are spaced apart from each other in a lateral direction. In this example, each of the two legs 4 comprises two apertures 6 or slots 6 (the second slot 6 of the leg 4 closest to the viewer and both of the two slots 6 of the leg on the left-hand side of the image are hidden from view by the base 3), although embodiments having only one aperture or slot per leg are also envisaged. These two slots 6 per leg are laterally spaced apart from each other on each leg such that each slot is provided on opposed sides of its respective leg, i.e. one slot 6 is provided on one side of a centreline of the leg 4 and the other slot 6 is provided on the other side of the centreline. The slots 6 are generally or substantially parallel to each other and each define a female receptacle for slidably receiving a corresponding respective lateral support finger 26, 29 (FIG. 2) of the hand trolley 7 as described herein below, the engagement of each slot 6 with its respective lateral support finger 19 providing lateral support or stability to the display platform when the display platform 1 is received by the hand trolley 7. The display platform of FIG. 1B, which is suitable for use with the present invention, is similar in many respects to the display platform of FIG. 1A and also comprises two spaced apart legs 4 which each have two apertures, slots or recesses 6 in the same as way as in the display platform of FIG. 1A. In contrast, the display platform of FIG. 1C, which is also suitable for use with the present invention, has a single aperture or slot 6 extending through each of the four legs 4 of the display platform (although examples wherein only one or two of the four legs, e.g. two legs on the same side of the display platform, comprise such an aperture of slot 6 are also envisaged and would be suitable for use with the present invention).

An example of a hand trolley 7 according to the present invention is shown in FIG. 2. The hand trolley 7 is generally L-shaped and comprises a generally upright rear portion 8, here in the form of a frame 8, as one of the “legs” of the L-shape and a generally horizontal display platform deck 9 as the other “leg” of the L-shape. As can be seen in the side view of FIG. 3, the display platform deck 9 and back portion 8 define between them an obtuse angle A, although other embodiments wherein the back portion 8 and the display platform deck 9 are substantially perpendicular to each other, or which define an acute angle between, them are also envisaged.

The back portion 8 or frame 8 comprises two laterally spaced apart upright supports 10 or members 10 and a plurality of structural members or rungs 11 extending therebetween. In this example a tubular member is bent in an inverted U-shape so as to define the two upright members 10 and a topmost rung 11, and three additional rungs 11 are provided as generally or substantially horizontal tubular members, the three additional rungs 11 being equidistant along the length of the upright members 10.

Part-way along the back portion 8, two handles 12 are provided, each handle 12 being attached to a respective upright support 10 by an inclined handle support 13 which extends rearwardly and upwardly from the back portion 8.

In this embodiment, two locomotive wheels 14 are provided at the rear of the base of the hand trolley 7 (although one of the two wheels 14 is obscured by the particular angle of the perspective view), although embodiments are envisaged wherein only one such wheel 14 is provided, similar to a wheelbarrow for example. Each rear wheel 14 is laterally spaced apart from each other and defines a rear wheel rotation axis 15 about which the rear wheel 14 rotates when the hand trolley 7 is in motion. In this example, the two rear wheels 14 are coaxial with each other, although this is not essential, such that they share a common rear wheel rotation axis 15. Thus, the hand trolley 7 can be tilted or tipped backwards about the wheel rotation axis 15 by a user applying downward pressure on the handles 12 and so the wheel rotation axis 15 in this embodiment also serves as a tilt axis 16 and in this way the hand trolley 7 acts as a first class lever in order to lift a fractional display platform 1 on the display platform deck 7, the handles 12 being provided on one side of the tilt axis 16 and the display platform deck 7 being provided on the other side. Thus, the tilt axis 16 in this embodiment is coaxial with the wheel rotation axis 15. Thus the hand trolley 7 may be tilted backwards (or rearwardly), in the usual way for hand trolleys, while transporting the fractional display platform 1 thereupon, into a wheeled transportation mode for transporting the display platform 1 on the trolley 7. Of course a tilt axis 16 could be provided in other ways, for example a ground-engageable stub could be provided on the underside of the hand trolley 7 to define a tilt axis 16 about which the trolley 7 could pivot or tilt, and so the tilt axis 16 would then be separate from (or in addition to) the wheel rotation axis 15. In the embodiment shown the rear wheels 14 are free-spinning and so are not powered but this is not essential and powered wheels may instead be used.

As best seen in FIG. 2, in addition to the locomotive wheels 14 provided at the rear of the base of the hand trolley 7, the hand trolley 7 also comprises a display platform deck wheel 17, or front wheel 17, arranged towards the front of the hand trolley 7 and attached to an underside of the display platform deck 9, the front wheel 17 being configured to support the display platform deck 7 on the ground when the hand trolley is not being tilted backwards. The front wheel 17, or display platform deck wheel 17, assists with the positioning of the display platform deck 9 under a display platform 1 so as to receive the display platform 1 before the display platform 1 is lifted off the ground by tilting the hand trolley 7 backwards about the tilt axis 16. The display platform deck wheel 17 may caster in some embodiments or, in others (as in this embodiment), it may not and may instead have a fixed axle or rotational axis. In this embodiment, the display platform deck wheel 17 is attached to the underside of a ledge 18 of the display platform deck 9. The ledge 18 is discussed in further detail below.

The hand trolley 7 comprises first 20 and second 21 display-platform-leg lateral support structures for providing lateral support to the display platform 1 when the display platform 1 is received by the hand trolley 7. In the embodiment of FIG. 2, the first display-platform-leg lateral support structure 20 is configured to engage with a first leg 4 of the display platform when the display platform 1 is received by the hand trolley 7 so as to laterally support the first leg 7 of the display platform in a first lateral direction (indicated by dashed arrow 22); and similarly the second display-platform-leg lateral support structure is configured to engage with the second leg of the display platform when the display platform is received by the hand trolley so as to laterally support the second leg of the display platform in a second lateral direction (indicated by dashed arrow 23), opposite to the first lateral direction, by the second display-platform-leg lateral support structure 21. However, embodiments of the hand trolley 7 are also envisaged having a first display-platform-leg lateral support structure 20 and a second display-platform-leg lateral support structure 22 which are both configured to engage with a first leg 4 of the display platform 1 when the display platform 1 is received by the hand trolley 7 so as to provide lateral support to the first leg 4 in both the first 22 and second 23 lateral directions—i.e. the first 20 and second 21 display-platform-leg lateral support structures are configured to engage with the same leg 4 of the display platform 1 when the display platform 1 is received by the trolley 7. As a point of note, the phrase “when the display platform 1 is received by the trolley 7” is intended to mean when the display platform 1 is positioned with respect to the trolley 7 such that one or more legs 4 of the display platform 1 is/are in engagement with the first 20 and second 21 display-platform-leg lateral support structures and is ready to be lifted or otherwise transported by the hand trolley 7.

While the present invention may be embodied in many different ways, the embodiment of FIG. 2 shows a preferred configuration of the first 20 and second 21 display-platform-leg lateral support structures, best seen in FIG. 4, in which the first 20 and second 21 display-platform-leg lateral support structures are laterally spaced apart from each other with a ledge 18 arranged therebetween. The first 20 and second 21 display-platform-leg lateral support structures are configured to provide interlocking engagement with the first 4 and second legs 4 of the display platform 1 respectively. In this embodiment, the first display-platform-leg lateral support structure 20 comprises a (lateral) support member 24 configured to slidingly engage with a side of the first leg 4 of the display platform 1 when the display platform 1 is received by the hand trolley 7 so as to provide lateral support to the display platform 1 on the trolley 7 in the first lateral direction 22. In this embodiment too, the first display-platform-leg lateral support structure 20 comprises a further (lateral) support member 25, here provided as an edge 25 of a ledge 18 of the display platform deck 9, configured to slidingly engage with an opposite side of the first leg 4 of the display platform 1 when the display platform 1 is received by the hand trolley 7 so as to provide lateral support to the display platform 1 on the trolley 7 in the second lateral direction 23 opposite to the first lateral direction 22. Thus one 24 of the support members slidingly engages one side of the display platform leg 4 and the other 25 slidingly engages the opposite side of the display platform leg 4 such that the two support members 24, 25 laterally support the first display platform leg 4 therebetween such that the display platform leg 4 is laterally supported in both the first 22 and second lateral directions 23. The ledge 18 is configured to be positioned, and to therefore extend, under the base 3 of the display platform 1 when the display platform 1 is received by the trolley 7 such that that the display platform 1 is carried for the most part on the ledge 18 (i.e. the centre of gravity of the display platform lies above the ledge 18). Consequently, the ledge 18 may extend beyond the middle of the display platform 1 when the display platform 1 is received by the trolley 7 so as to extend ahead (i.e. in the forward direction) of the centre of gravity of the display platform 1.

In this embodiment, the first lateral display-platform-leg support structure 20 also comprises two (although other embodiments may only comprise one, or may comprise more than two) laterally spaced-apart fingers 26, or projections 26, configured to be slidingly received by corresponding apertures 6, or slots 6, provided in the first leg 4 of the display platform 1 when the display platform 1 is slidingly received by the trolley 7 so as to provide lateral support to the display platform 1 on the trolley 7. The two fingers 26 define a void space, here provided as a slot 32 (FIG. 4) therebetween configured to slidingly receive (at least a portion of) the first leg 4 of the display platform 1. The fingers 26 and lateral support members 24 and 25 of the first display-platform-leg lateral support structure 20 are all arranged together in a common plane and extend in a forward direction of the hand trolley 7, i.e. away from the axis 16.

Similarly, the second display-platform-leg lateral support structure 21 comprises a (lateral) support member 27 configured to slidingly engage with a side of the second leg 4 of the display platform 1 when the display platform 1 is received by the hand trolley 7 so as to provide lateral support to the display platform 1 on the trolley 7 in the second lateral direction 23. In this embodiment too, the second display-platform-leg lateral support structure 21 comprises a further (lateral) support member 28, here provided as an edge 28 of the ledge 18 of the display platform deck 9, configured to slidingly engage with an opposite side of the second leg 4 of the display platform 1 when the display platform 1 is received by the hand trolley 7 so as to provide lateral support to the display platform 1 on the trolley 7 in the first lateral direction 22. Thus one 27 of the support members slidingly engages one side of the display platform leg 4 and the other 28 slidingly engages the opposite side of the display platform leg 4 such that the two support members 27, 28 laterally support the second display platform leg 4 therebetween such that the display platform leg 4 is laterally supported in both the first 22 and second lateral directions 23.

In this embodiment the second lateral display-platform-leg support structure 21 also comprises two (although other embodiments may only comprise one, or may comprise more than two) laterally spaced-apart fingers 29, or projections 29, configured to be slidingly received by corresponding apertures 6, or slots 6, provided in the second leg 4 of the display platform 1 when the display platform 1 is slidingly received by the trolley 7 so as to provide lateral support to the display platform 1 on the trolley 7. The two fingers 29 define a void space, here provided as a slot 32 (FIG. 4) therebetween configured to receive (at least a portion of) the second leg 4 of the display platform 1. The fingers 29 and lateral support members 27 and 28 of the second display-platform-leg lateral support structure 21 are all arranged together in a common plane and extend in a forward direction of the hand trolley, i.e. away from the axis 16.

The fingers and lateral support members of both the first 20 and second 21 display-platform-leg support structures all lie within the same common plane, and indeed so does the ledge 18 which itself is substantially planar. In this embodiment, display platform deck 9 comprises the fingers and lateral support members of both the first and second display-platform-leg support structures and also the ledge 18. Thus the fingers and all of the lateral support members of both the first and second display-platform-leg support structures and also the ledge 18 are all integrally formed with the display platform deck 9. The display platform deck 9 in this embodiment, although not essential, is formed of a substantially planar sheet of material and the first and second display-platform-leg lateral support structures are defined by a profiled edge 33 of the display platform deck 9, the profiled edge 33 being provided on a front edge of the display platform deck 9.

As can also be seen in FIG. 4, the ledge 18 comprises a guide portion 34 of reduced width compared to a second portion of the ledge 18. The guide portion 34 comprises a first 35 and a second 36 oppositely angled or rounded guide edges on respective opposed lateral sides of the ledge 18. Thus, the guide portion 34 facilitates the engagement of the ledge 18 between the first and second legs 4 of the display platform 1 as it helps to locate the display platform 1 on the trolley 7.

Turning now to FIG. 5, a display platform 1 is shown received by the display platform deck 9. The remainder of the hand trolley 7 is omitted from view for illustrative purposes. First 20 and second 21 display-platform-leg support structures are shown slidingly and matingly received within correspondingly apertures 6 provided in each leg 4 of the display platform 1. The display platform deck 9 shown here only differs from that of FIG. 2 in that one of the support members 24, 27 of each of the first 20 and second 21 display-platform-leg lateral support structures is omitted, such that each of the first 20 and second 21 display-platform-leg lateral support structures comprises support members 25 and 28, here in the form of an edge of the ledge 18, configured to slidingly engage with a side of respective legs of the display platform 1 when the display platform 1 is received by display platform deck 9 of the trolley 1. Two laterally spaced apart fingers 26 of the first display-platform-leg lateral support structure 20 are matingly and slidably received within corresponding apertures or slots 6 of a first leg 4 of the display platform 1 so as to provide lateral stability to the display platform 1 by laterally supporting the first display platform leg 4. Similarly, two laterally spaced apart fingers 29 of the second display-platform-leg lateral support structure 21 are matingly and slidably received within corresponding apertures or slots 6 of a second leg 4 of the display platform 1 so as to provide lateral stability to the display platform 1 by laterally supporting the second display platform leg 4. Thus, the first and second display platform legs 4 are laterally supported in both the first 22 and second 23 lateral directions by each of the set of two fingers 26 and 29. The first 20 and second 21 display-platform-leg lateral support structures are integrally formed with the display platform deck 9, the display platform deck 9 having a ledge 18 which is shown in FIG. 5 to extend beyond (i.e. ahead of) the centreline of the display platform (in a forward direction relative to the hand trolley) such that, when the display platform 1 is received by the display platform deck 9, the centre of gravity of the display platform 1 is located above the ledge 18 such that, when lifted, the display platform 1 is supported on the display platform deck 9. This means that when the display platform 1 is evenly loaded across its loading surface 2 with items to be carried by the display platform 1, the display platform 1 will not topple off of the display platform deck 9.

As will be appreciate, the present invention may take many different forms. Some of the various embodiments and configurations of the display platform deck 9 of the present invention are shown schematically in FIGS. 6A-6L in plan view. In each, there is a first 20 and a second 21 display-platform-leg lateral support structure configured to slidingly engaged with a display platform leg 4 when the display platform 1 is received by the trolley 7. In FIGS. 6A-6L, the display platform legs 4 are shown in dashed broken lines.

FIG. 6A shows an embodiment of a display platform deck 9 forming part of the present invention having a first display-platform-leg lateral support structure 20 comprising one support member 24 and having a second display-platform-leg lateral support structure 21 comprising another support member 27, each of the support members 24, 27 being configured to slidingly engage a side of a respective leg 4 of the display platform 1 so as to provide lateral stability to the display platform 1 in both the first 22 and second 23 lateral directions when the display platform 1 is received by the hand trolley 7. The display platform deck 9 is absent from this particular embodiment, but the same embodiment but with the display platform deck 9 included is shown in FIG. 6G.

FIG. 6B shows an embodiment of a display platform deck 9 forming part of the present invention having a first display-platform-leg lateral support structure 20 comprising a first support member 24 and a second support member 25 configured to slidingly engage and thereby laterally support a first display platform leg 4 therebetween so as to provide lateral stability to the first display platform leg 4 in both the first 22 and second 23 lateral directions, and a second display-platform-leg lateral support structure 21 comprising a first support member 27 and a second support member 28 configured to slidingly engage and thereby laterally support a second display platform leg 4 therebetween so as to provide lateral stability to the second display platform leg 4 in both the first 22 and second 23 lateral directions when the display platform 1 is received by the hand trolley 7. The display platform deck 9 is absent from this particular embodiment, but an embodiment in which the display platform deck 9 is provided is also envisaged.

FIG. 6B shows an embodiment of a display platform deck 9 forming part of the present invention having a first display-platform-leg lateral support structure 20 comprising a first support member 24 and a second support member 25 configured to slidingly engage and thereby laterally support a first display platform leg 4 therebetween so as to provide lateral stability to the first display platform leg 4 in both the first 22 and second 23 lateral directions, and a second display-platform-leg lateral support structure 21 comprising a first support member 27 and a second support member 28 configured to slidingly engage and thereby laterally support a second display platform leg 4 therebetween so as to provide lateral stability to the second display platform leg 4 in both the first 22 and second 23 lateral directions when the display platform 1 is received by the hand trolley 7. The display platform deck 9 is absent from this particular embodiment, but the same embodiment in which the display platform deck 9 is provided is also envisaged.

FIG. 6C shows an embodiment of a display platform deck 9 forming part of the present invention having a first display-platform-leg lateral support structure 20 comprising a finger 26 configured to be slidingly engaged and matingly received by a corresponding aperture 6 provided in a first leg 4 of the display platform 1, and thereby laterally support a first display platform leg 4 so as to provide lateral stability to the first display platform leg 4 in at least a first lateral direction 22 (but optionally in both the first and second lateral directions), and having a second display-platform-leg lateral support structure 21 comprising a finger 29 configured to be slidingly and matingly received by a corresponding aperture 6 provided in a second leg 4 of the display platform 1, and thereby laterally support a second display platform leg 4 so as to provide lateral stability to the second display platform leg 4 in at least a second lateral direction 22 (but optionally in both the first and second lateral directions). Thus, when the display platform 1 is received by the trolley 7, the display platform 1 is laterally supported in both the first 22 and second 23 lateral directions. The display platform deck 9 is absent from this particular embodiment but the same embodiment but with the display platform deck 9 included is shown in FIG. 6D.

FIG. 6E shows an embodiment of a display platform deck 9 forming part of the present invention having a first display-platform-leg lateral support structure 20 comprising two laterally spaced apart fingers 26 configured to be slidingly and matingly received by corresponding apertures 6 provided in a first leg 4 of the display platform 1, and thereby laterally support a first display platform leg 4 so as to provide lateral stability to the first display platform leg 4 in at least a first lateral direction 22 (but optionally in both the first and second lateral directions), and having a second display-platform-leg lateral support structure 21 comprising two laterally spaced apart fingers 29 configured to be slidingly and matingly received by corresponding apertures 6 provided in a second leg 4 of the display platform 1, and thereby laterally support a second display platform leg 4 so as to provide lateral stability to the second display platform leg 4 in at least a second lateral direction 22 (but optionally in both the first and second lateral directions). Thus, when the display platform 1 is received by the trolley 7, the display platform 1 is laterally supported in both the first 22 and second 23 lateral directions by the first 20 and second 21 display-platform-leg lateral support structures. The display platform deck 9 is absent from this particular embodiment but the same embodiment but with the display platform deck 9 included is shown in FIG. 6L.

FIG. 6F shows an embodiment of a display platform deck 9 forming part of the present invention having a first display-platform-leg lateral support structure 20 comprising a support member 25 (provided as an edge of the ledge 18) configured to slidingly engage with a side of a first display platform leg 4 so as to provide lateral stability thereto in a first lateral direction 23 and also comprising two laterally spaced apart fingers 29 configured to be slidingly and matingly received by corresponding apertures 6 provided in a first leg 4 of the display platform 1, and thereby laterally support a first display platform leg 4 so as to provide lateral stability to the first display platform leg 4 in at least a first lateral direction 23 (but optionally in both the first and second lateral directions), and the display platform deck 9 comprising a second display-platform-leg lateral support structure 21 comprising a support member 28 (provided as an edge of the ledge 18) configured to slidingly engage with a side of a second display platform leg 4 so as to provide lateral stability thereto, and thereby laterally support a second display platform leg 4 so as to provide lateral stability to the second display platform leg 4 in the second lateral direction 22, opposite the first lateral direction 23. Thus, when the display platform 1 is received by the trolley 7, the display platform 1 is laterally supported in both the first 22 and second 23 lateral directions by the first 20 and second 21 display-platform-leg lateral support structures.

FIG. 6H shows an embodiment of a display platform deck 9 forming part of the present invention essentially the same as the embodiment of FIG. 6F but in which the first display-platform-leg lateral support structure 20 comprises a single finger 29 rather than two.

FIG. 6I shows an embodiment of a display platform deck 9 forming part of the present invention similar to the embodiment of FIG. 6A but wherein the support members 24, 27 are configured to slidingly engage with corresponding internally-facing sides of their respective display platform legs 4, whereas in the embodiment of FIG. 6I the support members 24, 27 are configured to slidingly engage with corresponding externally-facing sides of their respective display platform legs 4. The display platform deck 9 is absent from this particular embodiment, but the same embodiment in which the display platform 9 is provided is also envisaged.

FIG. 6J shows an embodiment of a display platform deck 9 forming part of the present invention similar to the embodiment of FIG. 6A but wherein each of the first and second display-platform-leg lateral support structures additionally comprise a finger 26, 29 configured to be slidingly and matingly received by a corresponding aperture 6 provided in respective first and second legs 4 of the display platform 1. The display platform deck 9 is absent from this particular embodiment, but the same embodiment in which the display platform deck 9 is provided is also envisaged.

FIG. 6K shows an embodiment of a display platform deck 9 forming part of the present invention similar to the embodiment of FIG. 6I but wherein each of the first and second display-platform-leg lateral support structures additionally comprise a finger 26, 29 configured to be slidingly and matingly received by a corresponding aperture 6 provided in respective first and second legs 4 of the display platform 1. The display platform deck 9 is absent from this particular embodiment, but the same embodiment in which the display platform deck 9 is provided is also envisaged.

Of course in all of the embodiments shown herein, the first 20 and second 21 display-platform-leg lateral support structures are integrally formed with the display platform deck 9 and lie within a common plane of the planar display platform deck 9. However, neither of these two aspects are essential to the invention and embodiments are envisaged wherein, for example, the first 20 and second 21 display-platform-leg lateral support structures do not form a part of the display platform deck 9 (i.e. wherein the display platform deck 9 does not comprise the first 20 and second 21 display-platform-leg lateral support structures, or indeed wherein the display platform deck 9 comprises some of the display-platform-leg lateral support structures 20, 21 but not all, for example it may comprise the support members 24, 27 but not the fingers 26, 29, or it may comprise the fingers 26, 29 but not the support members 24, 27 and so on. In some embodiments the first 20 and second 21 display-platform-leg lateral support structures may be provided below, or indeed above, the display platform deck 9 as a separate component to the display platform deck 9 and, for example, may be attached to another part of the trolley 7, for example the frame 8, e.g. extending in a forward direction (i.e. away from the rear wheel rotation axis 15) therefrom.

Whereas in the embodiment of FIG. 2, a fixed front wheel 17 is used as a front support to support the front of the trolley 7 and especially to provide support to the front of the display platform deck 9, an alternative front support 37 for use with the embodiment of FIG. 2 is shown in side view in FIGS. 7A and 7B which also forms part of the present invention. The front support 37 is an extendable front support in that it is reconfigurable between an extended configuration and a retracted configuration. The extendable front support 37 has a greater height in the extended configuration than in the retracted configuration and so the extendable front support 37 supports a front portion 46 of the display platform deck 9 or ledge 18 higher off of the ground in the extended configuration than in the retracted configuration. Thus, when in the retracted configuration, the display platform deck 9 (and ledge 18 thereof) is tilted towards the ground at a front portion 46 thereof such that the front portion 46 is closer to the ground than a rear portion 47 of the display platform deck 9 when the trolley 7 is in a generally upright position (i.e. when it is supported on the ground by both the rear wheel or rear wheels and by the front support 37). In other words, the display platform deck 9 is in a declined configuration when the extendable front support 37 is in the retracted configuration and the display platform deck 9 is in an inclined configuration when the extendable front support 37 is in the extended configuration, wherein in the declined configuration the front portion 46 of the display platform deck 9 is closer to the ground than in the inclined configuration. Thus, in embodiments in which the display platform deck 9 is pivotally coupled to the trolley 7 (for example at a rear of the display platform deck 9), or coupled via means of a hinge, angle A (FIG. 3) is greater in the retracted configuration than in the extended configuration.

While the embodiment shown in FIG. 2 has a front wheel 17 having a fixed height as a front support 37 of the trolley 7, FIGS. 7A and 7B show an alternative front support 37 which may be used instead. The front support 37 of FIGS. 7A and 7B is an extendable front support 37 for supporting the front of the hand trolley 7 on the ground. In this particular example, the extendable front support 37 is in the form of a wheel 39 and a bracket 38, although other suitable extendable front supports could instead be used.

FIG. 7A shows the extendable front support 37 in an extended configuration while FIG. 7B shows the extendable front support 37 in a retracted configuration. The extendable front support 37 of FIGS. 7A and 7B comprises a bracket 38 and a front wheel 39, which in this example is a front wheel of the hand trolley 7. The bracket 38 is attached to the display platform deck 9 at the front portion of the display platform deck 9 spaced ahead of the rear wheel axis 15 and is attached to an underside of the display platform deck 9 but this is not essential. The bracket 38 is attached to the display platform deck 9 by fastening means 40, here provided as bolts 40 each with a corresponding nut extending through correspondingly spaced holes provided in the display platform deck. While the extendable front support 37 in this embodiment comprises a front wheel 37, other extendable front supports are also envisaged which do not comprise a front wheel but instead comprise a front support member such as a block or foot for example instead of the front wheel.

The bracket comprises two spaced apart legs 41 defining a space therebetween for receiving the front wheel 39, although other brackets could instead be used which only have one leg 41.

The bracket 38 comprises a guide 43 for guiding therealong an axle 42 of the front wheel 39. In this example, the guide 43 is provided as a slot 43 within each leg 41 of the bracket 38. The guide comprises a first stop 44 and a second stop 45, each being configured to receive the front wheel axle 42 and the guide 43 is configured to guide the front wheel axle 42 from the first stop 44 to the second stop 45 and vice versa. The first stop 44 and second stop 45 are arranged such that the first stop 44 is provided closer to the display platform deck 9 than the second stop 45 (i.e. the second stop 45 is spaced further away from the display platform deck 9 that the first stop 44 is spaced away from the display platform deck 9). Thus, when the axle 42 is received by the first stop 44, the distance from the wheel axle 42 to the display platform deck 9 is less than the distance from the wheel axle 42 to the display platform deck 9 when the axle 42 is received by the second stop 45 (i.e. the height of the extendable front support 37 is less when the axle 42 is received by the first stop 44 than when the axle 42 is received by the second stop 45). In this way, the first stop 44 defines the retracted configuration whereas the second stop 45 defines the extended configuration of the extendable front support 37. The slot 43 extends between the first 44 and second 45 stops and in this example is provided as a linear slot extending linearly between the first and second stops and so is inclined with respect to the display platform deck 9. Thus, the first 44 and second 45 stops are provided at opposed ends of the slot 43. The first stop 44 is spaced further from the rear wheel axle 15 or rear wheel rotation axis 15 than the second stop 45. Thus the slot 43 defines a track 43 for guiding the front support member therealong between the extended and retracted configurations. In examples where the bracket comprises two legs, the slot 43 of each leg 41 may optionally be identical to each other such that the front wheel axle 42 is received within both slots 43.

In this example, the first 44 and second stops 45 are provided as first 44 and second notches 45 respectively within the slot 43 and the first 44 and second 45 notches extend from the slot 43 generally upwards, generally towards the display platform deck 9, although other forms of stop are also envisaged.

As can be seen from a comparison of FIGS. 7A and 7B, when the trolley 7 is supported on the ground by both the at least one rear wheel and the front wheel (i.e. when the hand trolley is in a generally upright, non-tilted position or configuration) and when the extendable front support is in the retracted configuration, the front of the display platform deck is tilted more towards the ground than when the trolley is supported on the ground by both the at least one rear wheel and the front wheel (i.e. when the hand trolley is in a generally upright, non-tilted position or configuration) and when the extendable front support is in the front wheel extended configuration. By tilting the front of the display platform deck 9 towards the ground in this way, the display platform deck can be more easily or readily positioned so as to receive a display platform thereupon and to facilitate the positioning of the lateral support structures in sliding engagements with their respective legs of the display platform by sliding the display platform deck 9 within the gap 5 between the display platform base 3 and the ground.

FIGS. 8A to 8C show the way in which the extendable front support 37 may be configured from the extended and retracted configuration. In FIG. 8A, the extended front support 37 is in the extended configuration in that the front wheel axle 42 is received by the second stop 45. In this configuration, the trolley 7 may be wheeled around (either in the tilted configuration or even in the generally upright, non-tilted configuration or position of the hand trolley 7) with a display platform 1 received thereupon. Should a user wish to unload the display platform from the trolley, he simply tilts the trolley about the rear wheel axis 15 and the front wheel axle 42 drops from the second stop or notch 45 into the slot 43 under the weight of the front wheel 39. The front wheel 39 then engages with the ground and the user then manoeuvres (e.g. pulls) the trolley rearwardly via handles 12, causing the front wheel 39 to move along the slot 43 towards the first stop 44. Simultaneously, or with a small delay, the user then tilts the display platform back into the generally upright position and, under the weight of the hand trolley 7, the front wheel axle 42 slides along the slot 43 until it is received by the notch 44 defined by the first stop 44 such that extendable front support 37 is now in the retracted configuration in which the display platform deck 9 is tilted downwardly and such that the weight of the display platform 1 is now supported solely by the display platform's legs 4 and not by the display platform deck 9. The user then continues to manoeuvre (e.g. pull) the trolley 7 rearwardly such that the first 20 and second 21 lateral support structures disengage from their sliding engagement with their respectively display platform legs 4 and the display platform 1 becomes unloaded from (or disassociated with) the trolley 7.

FIGS. 9A to 9C show essentially the reverse process as that shown in FIGS. 8A to 8C in that they show the way in which the extendable front support 37 may be configured from the retracted configuration to the extended configuration. In FIG. 9A, the extended front support 37 is in the retracted configuration in that the front wheel axle 42 is received by the first stop 44. In this configuration, the trolley 7 may be wheeled around with a display platform 1 received thereby, but not thereupon. Should a user wish to load, i.e. lift, the display platform 1, onto the trolley 7, he simply tilts the trolley 7 about the rear wheel axis 15 and the front wheel axle 42 drops from the first stop or notch 44 into the slot 43 under the weight of the front wheel 39. The front wheel 39 then either slides under its own weight along slot 43 to the second stop 45 so as to be received by the second stop 45 or the front wheel 39 engages with the ground and the user then manoeuvres (e.g. pushes) the trolley 7 forwardly via handles 12, causing the front wheel 39 to move along the slot 43 towards the second stop 45. Simultaneously, or with a small delay, the user then tilts the display platform back into the generally upright position (i.e. so that the weight of the hand trolley 7 is supported by both the rear wheel 14 and the extendable front support 37) and, under the weight of the hand trolley 7 or because of the titling action being applied by the user, the front wheel axle 42 becomes received within the notched defined by the second stop 45 such that extendable front support 37 is now in the extended configuration and such that the weight of the display platform 1 is now supported by the display platform deck 9 and not by the display platform's legs' 4 engagement with the ground.

Thus, as shown in FIGS. 8A to 9C, the extendable front support 37 is configured such that tilting the hand trolley 7 rearwardly (e.g. about the rear wheel rotation axis 15) causes the extendable front support 37 to reconfigure from the extended configuration and the retracted configuration but also tilting the hand trolley 7 in the same way also causes the extendable front support 37 to reconfigured from the retracted configuration to the extended configuration. Thus, the same action is involved in configuring the extendable front support 37 between the extended and retracted configurations. This greatly improves the usability of the hand trolley 7.

Thus, in using the present invention, a user manoeuvres the trolley 7 up to a display platform to be transported and in doing so positions the trolley 7 so that the first and second display platform leg lateral support structures are aligned with the display platform leg(s) with which they are configured to slidingly engage. Once aligned, the user pushes the trolley further towards the display platform 1 (either on just the rear wheel or on the rear wheel and the front wheel) such that the first and second display platform leg lateral support structures slidingly engage with their respective display platform leg so as to provide lateral stability thereto. In embodiments comprising the ledge, the ledge may be positioned under the base of the display platform In embodiments comprising the extendable front support, the user then follows the procedure set out in FIGS. 9A to 9C to tilt the display platform deck 9 rearwardly so as to lift the display platform 1 onto the display platform deck 9. The display platform may then be transported on the trolley by pushing the trolley either in the generally upright position (in which both the rear wheel(s) and the front wheel is in engagement with the ground) or in the tilted configuration in which only the rear wheel is in engagement with the ground and in which the front wheel is not. When the user desires to unload the display platform 1 from the trolley 7, he may follow the procedure shown in FIGS. 8A to 8C to cause the display platform deck 9 to be tilted forwardly so as to effectively lower the display platform deck 9 such that the weight of the display platform 1 is now supported solely by its feet and not by the display platform deck 9. The trolley can then be slid backwards until the first and second display platform leg lateral support structures become slidingly disengaged with their respective display platform leg(s) 4 and the display platform 1 becomes disassociated with the hand trolley 7, ready for another display platform to be transported by the trolley 7.

It is envisaged that the skilled person in the art may make various changes to the embodiment specifically described above without departing from the scope of the invention.

1-54. (canceled)

55. A fractional display platform hand trolley for receiving and transporting a legged fractional display platform, the fractional display platform having a loading surface for carrying items on the fractional display platform and at least one leg for supporting the loading surface, the hand trolley comprising:
a first display-platform-leg lateral support structure for providing lateral support to the display platform; and
a second display-platform-leg lateral support structure for providing lateral support to the display platform,
wherein:
the first display-platform-leg lateral support structure is configured to engage with a leg of the display platform when the display platform is received by the hand trolley such that lateral support of display platform on the hand trolley is provided in a first lateral direction by the first display-platform-leg lateral support structure; and
the second display-platform-leg lateral support structure is configured to engage with a leg of the display platform when the display platform is received by the hand trolley such that lateral support of display platform on the hand trolley is provided in a second lateral direction, opposite to the first lateral direction, by the second display-platform-leg lateral support structure.

56. The hand trolley of claim 55, wherein the first display-platform-leg lateral support structure and second display-platform-leg lateral support structure are both configured to engage with a first leg of the display platform when the display platform is received by the hand trolley so as to provide lateral support to the first leg in both the first and second lateral directions.

57. The hand trolley of claim 55, wherein:
the first display-platform-leg lateral support structure is configured to engage with a first leg of the display platform when the display platform is received by the hand trolley so as to laterally support the first leg of the display platform in the first lateral direction, and
the second display-platform-leg lateral support structure is configured to engage with the second leg of the display platform when the display platform is received by the hand trolley so as to laterally support the second leg of the display platform in the second lateral direction.

58. The hand trolley of claim 57, wherein the first display-platform-leg lateral support structure comprises a support member configured to engage with a side of the first leg of the display platform when the display platform is received by the hand trolley so as to provide lateral support to the display platform on the trolley in the first lateral direction, optionally wherein the first display-platform-leg lateral support structure comprises a further support member configured to engage with an opposite side of the first leg of the display platform when the display platform is received by the hand trolley so as to provide lateral support to the display platform on the trolley in the second lateral direction.

59. The hand trolley of claim 57, wherein the first display-platform-leg lateral support structure comprises at least one finger configured to be slidingly received by a corresponding aperture provided in the first leg of the display platform when the display platform is received by the trolley, optionally so as to provide lateral support to the display platform on the trolley.

60. The hand trolley of claim 59, wherein the first display-platform-leg lateral support structure comprises two, optionally laterally spaced-apart, fingers configured to be slidingly received by corresponding apertures provided in the first leg of the display platform when the display platform is received by the trolley so as to provide lateral support to the display platform on the trolley.

61. The hand trolley of claim 60, wherein the two fingers define a finger void space therebetween, the finger void space being configured to receive a first leg of the display platform.

62. The hand trolley of claim 57, wherein the second display-platform-leg lateral support structure comprises a support member configured to engage with a side of the second leg of the display platform when the display platform is received by the hand trolley so as to provide lateral support to the display platform on the trolley in the second direction, optionally wherein the second display-platform-leg lateral support structure comprises a further support member configured to engage with an opposite side of the second leg of the display platform when the display platform is received by the hand trolley so as to provide lateral support to the display platform on the trolley in the first direction.

63. The hand trolley of claim 62, wherein the second display-platform-leg lateral support structure comprises at least one finger configured to be slidingly received by a corresponding aperture provided in the second leg of the display platform when the display platform is received by the trolley, optionally so as to provide lateral support to the display platform on the trolley.

64. The hand trolley of claim 62, wherein:
the second display-platform-leg lateral support structure comprises two, optionally laterally spaced-apart, fingers configured to be slidingly received by corresponding apertures provided in the second leg of the display platform when the display platform is received by the trolley so as to provide lateral support to the display platform on the trolley; and
the two fingers define a finger void space therebetween, the finger void space being configured to receive a first leg of the display platform.

65. The hand trolley of claim 55, wherein the hand trolley further comprises a display platform deck for receiving thereupon and thereafter transporting thereupon a legged fractional display platform when the legged fractional display platform is received by the trolley.

66. The hand trolley of claim 65, wherein the display platform deck comprises a ledge arranged between the first and second display-platform-leg lateral support structures, the ledge being configured to extend underneath the display platform and between the first and second legs of the display platform when the display platform is received by the trolley so as to support the display platform thereupon.

67. The hand trolley of claim 66, wherein the ledge comprises a guide portion of reduced width, for example the guide portion comprising a first and a second angled or rounded guide edge on respective opposed lateral sides of the ledge so as to facilitate the engagement of the ledge between the first and second legs of the display platform.

68. The hand trolley of claim 65, wherein one or more of:
the display platform deck is substantially planar;
the first and/or second display-platform-leg lateral support structures are integrally formed with the display platform deck; or
the first and/or second display-platform-leg lateral support structures are substantially co-planar with the display platform deck or ledge.

69. The hand trolley of claim 57, wherein:
the hand trolley further comprises a display platform deck for receiving thereupon and thereafter transporting thereupon a legged fractional display platform when the legged fractional display platform is received by the trolley, and
the display platform deck comprises:
a first display-platform-leg lateral support surface, or edge, configured to engage with the first leg of the display platform when the display platform is received by the hand trolley so as to provide lateral support the first leg of the display platform in the second lateral direction; and
a second display-platform-leg lateral support surface, or edge, configured to engage with the second leg of the display platform when the display platform is received by the hand trolley so as to provide lateral support to the second leg of the display platform in the first lateral direction.

70. The hand trolley of claim 55 wherein the first and second display-platform-leg lateral support structures are configured to provide interlocking engagement with the first and second legs of the display platform respectively.

71. The hand trolley of claim 65, wherein:
the two fingers define a finger void space therebetween, the finger void space being configured to receive a first leg of the display platform, and
the finger void spaces are provided as slots within the display platform deck.

72. The hand trolley of claim 65, wherein the display platform deck is substantially planar and wherein the first and second display-platform-leg lateral support structures are defined by a profiled edge of the display platform deck.

73. The hand trolley of claim 65, wherein the trolley comprises at least one locomotive wheel comprising a wheel rotation axis, and wherein the trolley is user-tiltable about a tilt-axis for lifting the display platform, wherein the tilt-axis is coaxial with the locomotive wheel rotation axis, into a wheeled transportation mode for transporting the display platform on the trolley.

74. The hand trolley of claim 73, wherein the trolley comprises at least one handle, preferably two handles, for manoeuvring the trolley, wherein the at least one handle is provided on one side of the tilt-axis and wherein the display platform deck is provided on the other side of the tilt-axis such that pushing the handle in one direction on one side of the tilt-axis causes the display platform deck to move in the opposite direction such that the trolley tilts about the tilt-axis so as to lift a display platform received by the trolley.

75. The hand trolley of claim 74, wherein:
the trolley comprises a substantially or generally upright frame to which the locomotive wheel, the display platform deck and at least one handle are attached, and.
the hand trolley comprises a substantially planar display platform deck for receiving thereupon and transporting thereupon a fractional display platform and wherein the frame extends generally upwardly so as to define an obtuse angle with the planar loading surface.

76. The hand trolley of claim 73, wherein:
the locomotive wheel is a rear wheel of the hand trolley, the rear wheel comprising a rear wheel rotation axis; and
the hand trolley further comprising:
an extendable front support spaced ahead of the rear wheel rotation axis;
the extendable front support being reconfigurable between an extended configuration and a retracted configuration, wherein the height of the front support in the extended configuration is greater than in the retracted configuration, such that, when the trolley is supported on the ground by both the at least one rear wheel and the extendable front support and when the extendable front support is in the retracted configuration, the display platform deck is tilted more towards the ground than when the trolley is supported on the ground by both the at least one rear wheel and the extendable front support and when the extendable front support is in the extended configuration.

77. The hand trolley of claim 76, wherein the extendable front support comprises a front support member and a bracket for mounting the front support member to the hand trolley.

78. The hand trolley of claim 77, wherein either:
the front support member comprises a front wheel comprising a front wheel axle, the extendable front support being reconfigurable between a front wheel extended configuration and a front wheel retracted configuration in which the distance between the front wheel axle and the display platform deck is less in the front wheel retracted configuration than in the front wheel extended configuration such that, when the trolley is supported on the ground by both the at least one rear wheel and the front wheel and when the extendable front support is in the front wheel retracted configuration, the display platform deck is tilted more towards the ground than when the trolley is supported on the ground by both the at least one rear wheel and the front wheel and when the extendable front support is in the front wheel extended configuration; or
the bracket comprises a first stop and a second stop, wherein both the first stop and second stop are configured to receive the front support member, the first stop is arranged closer to the display platform deck than the second stop is such that the first stop defines the front wheel retracted position, and the second stop defines the front wheel extended position, and a guide is configured to slidably guide the front wheel axle to and from the first stop and second stop.

79. The hand trolley of claim 76, wherein one or more of:
the extendable front support is arranged towards a front portion of the display platform deck,
the extendable front support is configured such that tilting the hand trolley about the rear wheel rotation axis causes the extendable front support to reconfigure to and from the extended configuration and the retracted configuration, or
the extendable front support is provided on an underside of the display platform deck.
